(19) United States
(12) Patent Application Publication
(10) Pub. No.: US 2022/0136519 A1
(43) Pub. Date: May 5, 2022

(54) DEVICE FOR COMPRESSING A FLUID DRIVEN BY AN ELECTRIC MACHINE WITH A COMPRESSION SHAFT PASSING THROUGH THE ROTOR

(71) Applicant: IFP Energies nouvelles, Rueil-Malmaison (FR)

(72) Inventors: Fabrice LE BERR, RUEIL-MALMAISON CEDEX (FR); Misa MILOSAVLJEVIC, RUEIL-MALMAISON CEDEX (FR); Denis GROSJEAN, RUEIL-MALMAISON CEDEX (FR)

(21) Appl. No.: 17/427,816

(22) PCT Filed: Jan. 14, 2020
(86) PCT No.: PCT/EP2020/050746

§ 371 Date: Aug. 2, 2021

(30) Foreign Application Priority Data
Feb. 4, 2019 (FR) 1901074

(51) Int. Cl. F04D 29/26; F04D 29/28; F04D 17/10; F04D 29/62; F04D 25/06; F02C 6/04

(52) U.S. Cl. CPC F04D 29/266; F04D 29/284; F04D 17/10; F05D 2220/40; F04D 25/06; F02C 6/04; F04D 29/624

(57) ABSTRACT

The present invention relates to a compression device (1) driven by an electric machine, for which a rotor (4) comprises a cylindrical magnet (5) and a binding ring (6). According to the invention, rotor (4) is mounted on compression shaft (3), and a nut (8) is provided to axially secure rotor (4) and compressor wheel (2) of compressor (1).

### CROSS-REFERENCE TO RELATED APPLICATIONS

This application is the national phase of PCT/EP2020/050746 filed Jan. 14, 2020, which claims the benefit of French Patent Application No. 19/01.074, filed Feb. 4, 2019, which are hereby incorporated herein by reference in their entirety.

### BACKGROUND OF THE INVENTION

### Field of the Invention

The present invention relates to the field of compression devices driven by an electric machine and in particular the invention concerns a turbocharger driven by an electric machine and notably relates to a device for compressing a gaseous fluid, such as air here, by a compressor, alone or associated with a turbine to form a turbocharger, prior to sending the compressed fluid to any device and, more particularly, to the intake of an internal-combustion engine.

### Description of the Prior Art

Indeed, as is widely known, the power delivered by an internal-combustion engine depends on the amount of air fed to the combustion chamber of this engine which is itself proportional to the density of the air.

Thus, it is usual to increase this amount of air through compression of the outside air before it is allowed into this combustion chamber when high power is required. This operation, known as turbocharging, can be carried out using any device such as a compressor alone, electrically driven by an electric machine (electrified compressor), or a compressor associated with a turbine and an electric machine to form an electrified turbocharger.

In the aforementioned two cases, the electric machine associated with the compressor can be of different types.

One is an electric machine with a small air gap and windings close to the rotor, which provides optimal guidance of the magnetic flux and optimized efficiency. This type of electric machine has the advantage of a certain compactness, which may sometimes be a problem regarding cooling thereof and requires a specific system for carrying off heat losses.

In order not to be intrusive on the air intake of the compressor, this type of electric machine is conventionally positioned on the back of the compressor in the case of an electrified compressor, or between the compressor and the turbine in the case of an electrified turbocharger, despite the presence of an unfavorable thermal environment in the latter case from being close to the turbine. Generally, the link between the compressor, the turbine and the electric machine is rigid. This type of machine can also be positioned on the compressor side, but relatively far from the air intake so as not to disturb it. The link between the compressor and the electric machine is then rigid or it is provided by a mechanical or a magnetic coupling.

This type of system is described in more detail in patents in published US patent applications and issued patents: 2014/0,373,532, U.S. Pat. Nos. 8,157,543, 8,882,478, 2010/0,247,342, 6,449,950, 7,360,361, and EP-0,874,953 or EP-0,912,821.

Another type of machine is an electric machine with a large air gap that may sometimes be several centimeters long which allows passage of the working fluid therethrough that enables integration as close as possible to the compression systems, in a significantly more favorable thermal environment.

This electric machine layout however involves the drawback of disturbing and limiting the passage of the magnetic flux between the rotor and the stator through the large air gap, and thereby contributes to limiting the intrinsic efficiency of the electric machine and the specific performances thereof (power-to-weight ratio and power density). The high losses with this type of design also require specific cooling to discharge the heat from the rotor and the stator or to limit the specific performances.

This type of electric machine is notably described in EP-1,995,429 and US published patent applications 2013/169,074 and 2013/043,745.

A third type of electric machine is a machine provided with a stator grid, which is an electric machine having a stator with stator teeth around which coils are mounted which stator teeth have large dimensions allowing passage of the air stream. This type of machine is an electric machine with a small air gap and windings positioned away from the rotor which can be arranged at the compressor intake. Such a stator grid machine is notably described in patent applications WO-2013/050,577 and FR-3,048,022.

One problem related to the electrification of compressors concerns the design of the rotor and its connection to the compressor shaft. This design is often complex (use of screws) and it is expensive to provide good coaxiality of the rotor and of the compressor shaft, as required for operation at very high rotational speeds.

Patent application FR-17/61,576 describes several electric rotor structures and structures for mounting on the shaft of a turbocharger, by adding a rotor to a shaft opening onto the compressor side. These structures provide for integration of rotors on already existing turbochargers. However, these structures are most often not readily compatible with an industrial mass production manufacturing process, considering the manufacturing tolerances and the rotor balancing operations required in order to obtain such a system.

### SUMMARY OF THE INVENTION

In order to reduce the complexity of the manufacturing and assembly method, and to be compatible with an industrial mass production manufacturing process, the present invention is a compression device driven by an electric machine in which the rotor comprises a cylindrical magnet and a non-magnetic binding ring. According to the invention, the rotor is mounted on the compression shaft, and a nut is provided to axially secure the rotor and the compressor wheel of the compressor. Thus, the compression shaft extends through the rotor, which reduces the complexity of the parts to be manufactured, regarding the shape of the components or the manufacturing tolerances. Furthermore, the invention reduces the number of operations required in the manufacturing and assembly process and in particular the balancing operations which may be expensive.

The invention relates to a fluid compression device driven by an electric machine. The electric machine comprises a rotor and a stator, a compression shaft on which at least one compressor wheel is mounted. The rotor comprises a cylindrical magnet and a binding ring for retaining the magnet. The rotor is mounted on the compression shaft and a nut is arranged at the end of the compression shaft to axially secure the rotor and the compressor wheel.

According to an embodiment, the rotor comprises a means of supporting the cylindrical magnet, which is cylindrical and arranged around the compression shaft.

Preferably, the support means is a cylindrical sleeve.

According to an aspect, the cylindrical sleeve abuts against the compressor wheel and against the nut.

Advantageously, the cylindrical sleeve abuts against a system for guiding the compression shaft and against the nut.

In a variant, the compressor wheel is mounted on the cylindrical sleeve.

Alternatively, the compressor wheel comprises the support means.

According to an implementation, the outside diameter of the rotor is less than or equal to the diameter of a nose of the compressor wheel.

According to an aspect, the rotor comprises at least one non-magnetic stop on one side of the magnet.

According to an option, the binding ring is made of a non-magnetic material, preferably titanium or carbon.

According to a feature, the compression device is a turbocharger combining a turbine and a compressor, notably for an internal-combustion engine, or a microturbine.

Advantageously, the electric machine is arranged in the gas intake of the turbocharger.

According to an embodiment, the electric machine is a stator grid machine.

Furthermore, the invention relates to a method of manufacturing a compression device driven by an electric machine, the electric machine comprising a rotor and a stator, the compression device comprising a compression shaft on which at least one compressor wheel is mounted. For this method, the following steps are carried out:

a) mounting the compressor wheel onto the compression shaft;

b) mounting a cylindrical magnet onto a support means arranged on the compression shaft;

c) radially retaining the cylindrical magnet radially by a binding ring; and

d) axially securing the rotor and the compressor wheel by a nut arranged at the end of the compression shaft.

### BRIEF DESCRIPTION OF THE FIGURES

Other features and advantages of the device and of the method according to the invention will be clear from reading the description hereafter of embodiments, given by way of non limitative example, with reference to the accompanying figures wherein:

FIG. 1 illustrates a compression device driven by an electric machine according to a first embodiment of the invention;

FIG. 2 illustrates a compression device driven by an electric machine according to a second embodiment of the invention; and

FIG. 3 illustrates a compression device driven by an electric machine according to a third embodiment of the invention.

### DETAILED DESCRIPTION OF THE INVENTION

The present invention relates to a device for compressing a fluid, notably gas, driven by an electric machine. In other words, the invention relates to the assembly made up of the electric machine and the compression device. Preferably, the compression device is air compression device.

The fluid compression device comprises a shaft, referred to as compression shaft, on which a compressor wheel (also referred to as blade) is mounted.

The electric machine comprises a rotor and a stator. The rotor is mounted on the compression shaft for transmitting or drawing the torque of the electric machine to the compression shaft and the compressor wheel, and vice versa.

The rotor comprises at least:
a cylindrical magnet which interacts with stator coils to generate the rotational motion of the rotor; and
a binding ring, preferably made of a non-magnetic material, titanium or carbon for example, for compressing the magnet and axially retaining the cylindrical magnet of the rotor, and the binding ring can have a substantially cylindrical shape surrounding the cylindrical magnet. Moreover, the non-magnetic material prevents magnetic losses.

According to the invention, the rotor is mounted on the compression shaft, and a nut is arranged at the end of the compression shaft for axially securing the rotor and the compressor wheel. In other words, the compression shaft extends through the rotor, and the assembly is secured by a nut arranged at the outlet end of the compression shaft. Thus, the rotor rests on one side against the compressor wheel and on the other side against the nut. The rotor therefore requires no fastening means, in particular a threading/tapping system, with the compression shaft (as it is the case for the embodiments described in patent application No. FR-17/61,576). Thus, the coaxiality and holding functions are disjoint, which facilitates mounting operations. Furthermore, the compression shaft is longer than the one described in the aforementioned prior application, which facilitates the design thereof. The invention thus reduces the complexity of the assembly, reduces the number of operations in the method of manufacturing and assembling the compression device, and reduces the complexity of the parts to be manufactured. The nut can also exert a preload on the rotor, the compressor and a system for guiding the compressor (bearing) with respect to a casing.

According to an embodiment of the invention, the rotor can also comprise a means of supporting the cylindrical magnet which is positioned between the compression shaft and the cylindrical magnet. The purpose of the support means is to facilitate the coaxiality of the rotor and the compression shaft. The support means has an internal bore of the same diameter as the compression shaft. For this embodiment, the support means can be cylindrical. The support means is referred to as cylindrical because it has an outer surface with at least one cylindrical portion for positioning the cylindrical magnet of the rotor. According to some embodiments, the support means can have cylindrical portions with different outside diameters.

According to a first implementation of this embodiment, the support means of the cylindrical magnet can be a cylindrical sleeve. The binding ring then exerts a radial compression of the cylindrical magnet on the cylindrical sleeve. Preferably, the cylindrical sleeve can be made of a magnetic material.

According to a first variant of this first implementation, the cylindrical sleeve can have a length equal to the length of the rotor. In this case, the cylindrical sleeve can abut on one side against the compressor wheel and, on the other side, against the nut. For this embodiment, the cylindrical sleeve can comprise a shoulder, and the shoulder can be in contact with the compressor wheel or with the nut. For the assembly of this variant, the rotor is assembled on the compression device after previously positioning the compressor wheel on the compression shaft. This variant embodiment allows each element to be made of the material that best matches the purpose thereof.

According to a second variant of this first implementation, the cylindrical sleeve can have a length corresponding to the cumulative length of the rotor and of the compressor wheel. In this case, the compressor wheel is mounted on a portion of the cylindrical sleeve. Furthermore, the cylindrical sleeve can abut on one side against the nut and on the other side against a compressor guide system (a bearing or a plain bearing for example). The cylindrical sleeve can have three cylindrical portions whose diameters may be different, one for setting the compressor wheel, one for setting the cylindrical magnet, and a shoulder between the other two portions. For this variant, the assembly is obtained by mounting the compressor wheel on the cylindrical sleeve, to provide a preliminary rotor assembly with the compressor wheel and to balance the system at once. In this assembly, the compressor wheel can be held on the cylindrical sleeve by binding, gluing, by an axial prestressing system or any similar means. One advantage of this variant is that it allows increasing the rigidity at the compressor wheel axle, which increases the values of the critical bending speeds. Indeed, the portion of the compression shaft under the compressor wheel may be a critical point for some bending modes.

According to a second implementation of the invention, the compressor wheel can comprise the cylindrical support means. In other words, the compressor wheel and the cylindrical support means make up a single monobloc piece. The support means is then an axial extension, of cylindrical shape, of the compressor wheel. The assembly of this implementation can comprise the steps of assembling the rotor on the axial extension of the compressor wheel. This implementation of the invention provides a system that has been previously assembled and balanced at once. Furthermore, this implementation of the invention limits the number of parts, and therefore the number of steps of assembling the compression device.

Preferably, the rotor according to the invention can radially comprise at most the following elements: support means (cylindrical sleeve or extension of the compressor wheel), cylindrical magnet and binding ring, all mounted on the compression shaft.

Alternatively, the rotor may have no support means, and the cylindrical magnet can be arranged directly around the compression shaft. This option allows limiting the components and therefore the steps of assembling the device.

According to an aspect of the invention, the rotor can further comprise a non-magnetic stop on at least one side of the magnet (longitudinally). This non-magnetic stop prevents magnetic losses from the magnet to the compressor wheel. The non-magnetic stop can also act as a thermal barrier by protecting the temperature-sensitive magnet. This non-magnetic stop can have the shape of a ring inserted between a shoulder of the compressor wheel and the cylindrical magnet. In other words, the non-magnetic stop can be axially interposed between the magnet and the compressor wheel.

Preferably, the electric machine can be mounted on the intake side of the compression device. For this preferred embodiment, the rotor of the electric machine can rest, on one side, against the compressor wheel and, on the other side, against the nut. Thus, mounting of the assembly is easier and the overall size is limited to the maximum. In other words, the electric machine can be adjacent to the compressor wheel on the intake side thereof.

According to an embodiment of the invention, the outside diameter of the rotor (here the binding ring) can be less than or equal to the diameter of the compressor wheel nose. The gas flow at the compression device inlet is thus not hindered by the rotor shaft.

According to an implementation of the invention, the compression device can be a turbocharger, notably for an internal-combustion engine of a vehicle. It is then a turbocharger driven by an electric machine. In this case, the compression shaft corresponds to the turbocharger shaft that connects the turbocharger turbine to the turbocharger compressor. The electric machine thus drives both the compressor and the turbine.

According to a variant of this implementation of the invention, the electric machine can be arranged in the gas (generally air) intake of the turbocharger system. This solution involves a double advantage: the electric machine can be cooled by the intake gas stream, and the intake gas is heated by the electric machine, which may be favorable for some operating modes of the internal-combustion engine.

Preferably, the electric machine can be a stator grid electric machine, i.e. an electric machine having a stator with stator teeth around which coils are mounted, and these stator teeth have large dimensions to allow passage of the air stream. Such a stator grid machine is notably described in patent applications WO-2013/050,577 and FR-3,048,022.

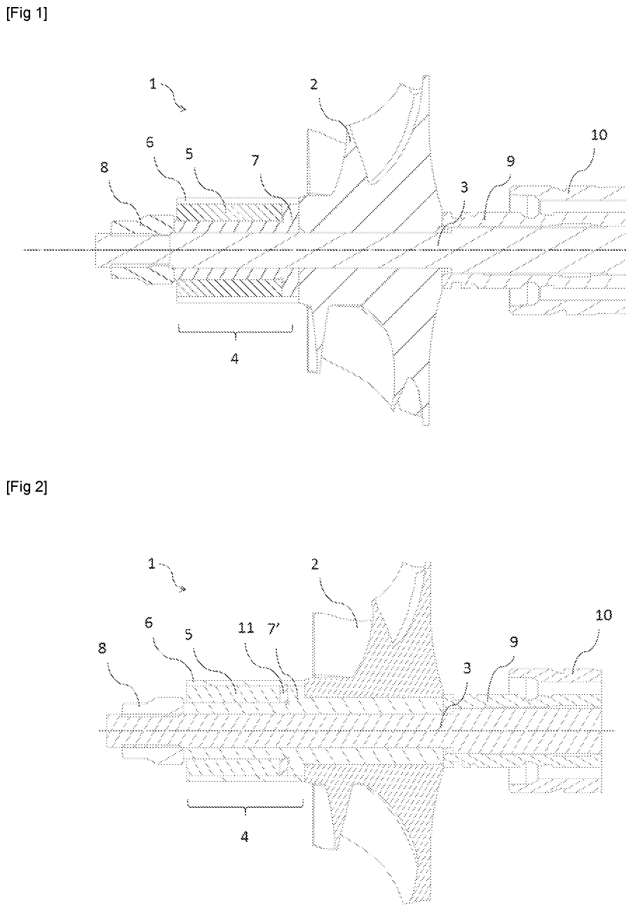

FIG. 1 schematically illustrates, by way of non-limitative example, a first embodiment of the invention. FIG. 1 is a sectional view of compression device 1 driven by an electric machine. The embodiment of FIG. 1 corresponds to the first variant of the first implementation described above. Compression device 1 comprises a compression shaft 3 on which a compressor wheel 2 and a rotor 4 are mounted. The end of compression shaft 3 is threaded for mounting a nut 8 that axially secures rotor 4 and compressor wheel 2. Rotor 4 is arranged between compressor wheel 2 and nut 8. Rotor 4 is a cylindrical sleeve 7 used as a support, a cylindrical magnet 5 and a binding ring 6. Cylindrical sleeve 7, which can be made of a magnetic material, has the same length as rotor 4, and abuts against nut 8 and compressor wheel 2. On the side of compressor wheel 2, cylindrical sleeve 7 comprises a shoulder whose outside diameter corresponds to the inside diameter of binding ring 6. Cylindrical sleeve 7 is mounted on compression shaft 3. Cylindrical magnet 5 is mounted on cylindrical sleeve 7. Binding ring 6 secures cylindrical magnet 5 on cylindrical sleeve 7. The outside diameter of ring 6 is substantially equal to the diameter of the nose of compressor wheel 2. On the other side, compressor wheel 2 abuts against a guide system 9, for example the inner ring of a bearing whose outer ring 10 is shown.

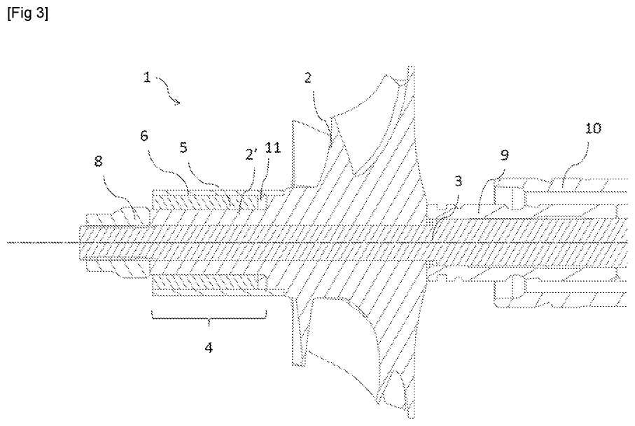

FIG. 2 schematically illustrates, by way of non-limitative example, a second embodiment of the invention. FIG. 2 is a sectional view of compression device 1 driven by an electric machine. The embodiment of FIG. 2 corresponds to the second variant of the first implementation described above. Compression device 1 comprises a compression shaft 3 on which a compressor wheel 2 and a rotor 4 are mounted. The end of compression shaft 3 is threaded for mounting a nut 8 that axially secures rotor 4 and compressor wheel 2. Rotor 4 is arranged between compressor wheel 2 and nut 8. Rotor 4 consists of a cylindrical sleeve 7′ used as a support means, a cylindrical magnet 5 and a binding ring 6. The length of cylindrical sleeve 7′, which can be made of a magnetic material, is slightly greater than the cumulative length of rotor 4 and the compressor wheel, and it abuts against nut 8 and a guide system 9. Cylindrical sleeve 7′ is mounted on compression shaft 3. Compressor wheel 2 is mounted on a cylindrical extremal portion of cylindrical sleeve 7′. Cylindrical magnet 5 is mounted on another extremal portion of cylindrical sleeve 7′. Binding ring 6 secures cylindrical magnet 5 on cylindrical sleeve 7′. Furthermore, cylindrical sleeve 7′ has a shoulder between the extremal portions, whose outside diameter corresponds to the inside diameter of binding ring 6. The outside diameter of ring 6 is substantially equal to the diameter of the nose of compressor wheel 2. On the other side, compressor wheel 2 and cylindrical sleeve 7′ abut against a guide system 9, for example the inner ring of a bearing whose outer ring 10 is shown.

FIG. 3 schematically illustrates, by way of non-limitative example, a third embodiment of the invention. FIG. 3 is a sectional view of compression device 1 driven by an electric machine. The embodiment of FIG. 3 corresponds to the third implementation described above. Compression device 1 comprises a compression shaft 3 on which a compressor wheel 2 and a rotor 4 are mounted. The end of compression shaft 3 is threaded for mounting a nut 8 that axially secures rotor 4 and compressor wheel 2. Rotor 4 is arranged between compressor wheel 2 and nut 8. Rotor 4 has a support means 2′, a cylindrical magnet 5 and a binding ring 6. Support means 2′ belongs to the same part as compressor wheel 2. Support means 2′ is a cylindrical portion axially extending compressor wheel 2. Cylindrical magnet 5 is mounted on cylindrical portion 2′ axially extending compressor wheel 2. Binding ring 6 secures cylindrical magnet 5 on support means 2′. Furthermore, the rotor comprises a non-magnetic stop 11 between compressor wheel 2 and cylindrical magnet 5. The outside diameter of ring 6 is substantially equal to the diameter of the nose of compressor wheel 2. On the other side, compressor wheel 2 abuts against a guide system 9, for example the inner ring of a bearing whose outer ring 10 is shown.

Moreover, the invention relates to a method of manufacturing a compression device driven by an electric machine comprising a rotor and a stator, and the compression device comprises a compression shaft and a compressor wheel. For this method, the following steps are carried out:

a. mounting the compressor wheel onto the compression shaft;

b. mounting a rotor onto a support means arranged around the compression shaft;

c. retaining the cylindrical magnet on the support means by a binding ring, which is preferably non-magnetic, the ring compressing the magnet and the support means, and the ring is substantially cylindrical,

d. axially securing the rotor and the compressor wheel with a nut positioned at the end of the compression shaft.

Advantageously, the manufacturing method can be intended for the manufacture of a compression device according to any one of the variants or variant combinations described above. For example, the manufacturing method can be intended for the manufacture of a compression device as described in connection with one of FIGS. 1 to 3.

For the first embodiment of FIG. 1, step b) can further comprise a substep of mounting cylindrical magnet 5 onto support piece 7, as well as binding ring 6 and optimally a non-magnetic stop on compression shaft 3.

For the second embodiment of FIG. 2, step a) can comprise a preliminary step of mounting compressor wheel 2 onto cylindrical sleeve 7′ (support means) by binding, gluing, by means of an axial prestress system or any similar means, and a substep of mounting the assembly made up of compressor wheel 2 and cylindrical sleeve 7′ onto compression shaft 3. This embodiment allows device 1 to be balanced at once.

For the third embodiment of FIG. 3, step b) can consist in mounting cylindrical magnet 5 with binding ring 6 and possibly non-magnetic stop 11 on cylindrical portion 2′ extending compressor wheel 2 (support means). This embodiment of the invention provides a system that has been previously assembled and balanced at once.

According to an embodiment of the method, the assembly made up of the compression device, or possibly the turbocharger, and the electric machine can be installed in an air loop of an internal-combustion engine.

Advantageously, the electric machine can be arranged in the air intake pipe, so that the air stream entering the compression device first flows through the electric machine. This solution has a double advantage which is the electric machine can be cooled by the intake gas stream and the intake gas can be heated by the electric machine, which can be favorable for some operating modes of the internal-combustion engine.

The manufacturing method may further comprise a step of installing the stator around the rotor.

Advantageously, the manufacturing method according to the invention can concern the electrification of a compression device or of a conventional turbocharger (equipped with a compressor wheel and a compression shaft, but initially without an electric drive). Therefore, the compressor wheel and the compression shaft can be a wheel and a shaft for which steps a) to d) described above are carried out.

In this case, the method can comprise an additional step of replacing the compression shaft with a longer compression shaft.

Besides, the invention is also suited for energy production systems such as microturbines.

The invention provides the following functional advantages of:

Creating a magnetic rotor allowing the shaft to be rotated through the generation of a rotating magnetic field by a stator comprising magnetic flux generators such as windings (three-phase windings for example);

Ensuring the mechanical strength of the rotor assembly, notably with respect to the centrifugal forces applied upon rotation, notably by use of the binding ring;

Guaranteeing good electrical performances, in terms of power as well as efficiency, to limit internal heating of the rotor (and therefore demagnetization) and to simplify cooling thereof;

Observing a high level of concentricity between the electric rotor and the turbocharger shaft to obtain a complete mechanical system (turbocharger shaft with electric machine rotor) that can be balanced with minimum unbalance;

Having a structure compatible with the assembly of the compressor wheel with the rotor on the turbocharger shaft, notably by use of the nut;

Tightening the compressor wheel with the rotor and preloading the roller bearings of the turbocharger, notably by use of the nut; and

Being compatible with an electric turbocharger mass production tooling and manufacturing method.

1-14. (canceled)

15. A fluid compression device driven by an electric machine including a rotor and a stator, the compression device comprising a compression shaft on which at least one compressor wheel is mounted, the rotor comprising a cylindrical magnet and a binding ring for retaining the cylindrical magnet, the rotor being mounted on the compression shaft on the intake side of the compression shaft, and a nut is on an end of the compression shaft which axially secures the rotor and the compressor wheel, and the rotor rests on one side against the compressor wheel and on another side against the nut.

16. A compression device as claimed in claim 15, wherein the rotor comprises means for supporting the cylindrical magnet which is cylindrical and located around the compression shaft.

17. A compression device as claimed in claim 16, wherein the means for supporting is a cylindrical sleeve.

18. A compression device as claimed in claim 17, wherein the cylindrical sleeve abuts against the compressor wheel and against the nut.

19. A compression device as claimed in claim 17, wherein the cylindrical sleeve abuts against a system for guiding the compression shaft and against the nut.

20. A compression device as claimed in claim 17, wherein the compressor wheel is mounted on the cylindrical sleeve.

21. A compression device as claimed in claim 19, wherein the compressor wheel is mounted on the cylindrical sleeve.

22. A compression device as claimed in claim 16, wherein the compressor wheel comprises the means for supporting.

23. A compression device as claimed in claim 15, wherein an outside diameter of the rotor is less than or equal to a diameter of a nose of the compressor wheel.

24. A compression device as claimed in claim 15, wherein the rotor comprises at least one non-magnetic stop located on one side of the cylindrical magnet.

25. A compression device as claimed in claim 15, wherein the binding ring comprises titanium or carbon.

26. A compression device as claimed in claim 15, wherein the compression device is a turbocharger which combines a turbine and a compressor for use in an internal-combustion engine or a microturbine.

27. A compression device as claimed in claim 26, wherein the electric machine is located in a gas intake of the turbocharger.

28. A compression device as claimed in claim 15, wherein the electric machine is a stator grid machine.

29. A method of manufacturing a compression device driven by an electric machine including a rotor and a stator, the device comprising a compression shaft on which at least one compressor wheel is mounted, comprising the steps of:
a) mounting the compressor wheel onto the compression shaft;
b) mounting a cylindrical magnet onto a support located on the compression shaft on an intake side of the compression device;
c) retaining the cylindrical magnet radially by a binding ring; and
d) axially securing the rotor and the compressor wheel by a nut arranged at an end of the compression shaft with the rotor resting on one side against the compressor wheel and on another side against the nut.
